(19) United States
(12) Patent Application Publication
(10) Pub. No.: US 2015/0344181 A1
(43) Pub. Date: Dec. 3, 2015

(54) Sealable Collapsible Container

(71) Applicants: Katrina Goff Candy, Echuca (AU); Ian Victor Chaffey, Echuca (AU)

(72) Inventors: Katrina Goff Candy, Echuca (AU); Ian Victor Chaffey, Echuca (AU)

(21) Appl. No.: 14/669,455

(22) Filed: Mar. 26, 2015

(30) Foreign Application Priority Data
May 27, 2014 (AU) 20144901993

(51) Int. Cl. B65D 21/08; A61J 11/04; A61J 11/00; B65D 1/02; B65D 1/42

(52) U.S. Cl. CPC B65D 21/086; B65D 1/0246; B65D 1/42; A61J 11/008; A61J 11/04

(57) ABSTRACT

The present invention relates to a sealable collapsible container comprising a top portion including a lip, a body portion and a base portion, the body portion of the container structured with a series of horizontal inclusions forming collapsible scored corrugations capable of nesting together and a clip structure capable of securing the nested scored corrugations. When the container is fully expanded, it can contain and hold a maximum amount of a product, usually a liquid. The container may be compressed once the product is dispensed by applying downward pressure to the lip of the container. When fully compressed the container may be easily disposed of and helps to alleviate environmental waste disposal issues by reducing the volume of waste and assisting the waste recycling process.

### CROSS-REFERENCE TO RELATED APPLICATIONS

This application is a continuation-in-part of provisional Australian patent application no. 20144901993 filed May 27, 2014.

### FEDERALLY SPONSORED RESEARCH AND DEVELOPMENT

None.

### APPENDICES

None.

### BACKGROUND OF THE INVENTION

The present invention relates to a collapsible container and also relates to a container dispensing a product. The container is preferably a bottle or carton but other types of containers are encompassed within the scope of the invention.

Many disposable containers, such as bottles or cartons are sold or distributed for containing products such as water, flavoured drinks and pharmaceutical products. Many of these containers pose an environmental land fill, recycling and pollution problem. In dispensing such products from their containers, consumers are often left with an empty bottle or carton which may then be collapsed for disposal. The present invention seeks to facilitate the reduction in the volume of waste produced of containers by reducing the size of the leftover container to a collapsible form.

### SUMMARY OF THE INVENTION

According to the present invention there is provided a collapsible container for containing, holding and dispensing a product, either a gas or liquid but usually a liquid; additionally the product could be a solid such as a powder or pellet material such as pills, capsules or similar substances. Typical products intended for use with the invention may include water, flavoured drinks including milk, soft drink, sodas, tea or pharmaceuticals, etc. although any liquid product is envisioned to be used by the invention. Additionally, the container may be provided with a traditional lip cap or a variety of liquid delivery caps such as teat cap.

The sealable collapsible container of the present invention comprises a top portion including a lip, a body portion and a base portion, the body portion of the container structured with a series of horizontal inclusions forming collapsible scored corrugations capable of nesting together and a clip structure capable of securing the nested scored corrugations. When the container is fully expanded, it can contain and hold a maximum amount of fluid or liquid. The container may be compressed once the product is dispensed by applying downward pressure to the lip of the container. When fully compressed the container may be easily disposed of and helps to alleviate environmental waste disposal issues by reducing the volume of waste and assisting the waste recycling process.

The present invention also provides the option of reducing the container in size as the product is dispensed or storing the container in its collapsed form, until needing to be filled thereby reducing container storage requirements. The invention further includes a container as above described which contains a product.

For a better understanding of the invention and to show how it may be carried into effect, preferred embodiments thereof will now be described, by way of unlimiting example only, with reference to the accompanying drawings.

### BRIEF DESCRIPTION OF THE SEVERAL VIEWS OF THE DRAWINGS

FIG. 1 is a side view of a container in expanded form in accordance with the preferred embodiment of the invention.

FIG. 1a is a top view of the container in expanded form of FIG. 1 in accordance with the preferred embodiment of the invention.

FIG. 1b is a detailed exploded view of the interior of a container in expanded form of FIG. 1 in accordance with the preferred embodiment of the invention.

FIG. 1c is a detailed view of a container in expanded form of FIG. 1 in accordance with the preferred embodiment of the invention.

FIG. 2 is a side view of the container of FIG. 1 having been partially collapsed towards its base portion in accordance with the preferred embodiment of the invention.

FIG. 2a is a top view of the container of FIG. 1 having been partially collapsed towards its base portion in accordance with the preferred embodiment of the invention.

FIG. 2b is a detailed view of the container of FIG. 1 having been partially collapsed towards its base portion in accordance with the preferred embodiment of the invention.

FIG. 2c is a detailed view of the container of FIG. 1 having been partially collapsed towards its base portion in accordance with the preferred embodiment of the invention.

FIG. 3 is a side view of the container of FIG. 1 having been fully collapsed towards its base portion in accordance with the preferred embodiment of the invention.

FIG. 3a is a top view of the container of FIG. 1 having been fully collapsed towards its base portion in accordance with the preferred embodiment of the invention.

FIG. 3b is a detailed exploded view of the interior of the container of FIG. 1 having been fully collapsed towards its base portion in accordance with the preferred embodiment of the invention.

FIG. 4 is a side view of a container in expanded form in accordance with another embodiment of the invention.

FIG. 4a is a top view of the container in expanded form of FIG. 4 in accordance with another embodiment of the invention.

FIG. 4b is a detailed exploded view of the interior of a container in expanded form of FIG. 4 in accordance with another embodiment of the invention.

FIG. 4c is a detailed view of a container in expanded form of FIG. 4 in accordance with another embodiment of the invention.

FIG. 5 is a side view of the container of FIG. 4 having been partially collapsed towards its base portion in accordance with another embodiment of the invention.

FIG. 5a is a top view of the container of FIG. 4 having been partially collapsed towards its base portion in accordance with another embodiment of the invention.

FIG. 5b is a detailed exploded view of the container of FIG. 4 having been partially collapsed towards its base portion in accordance with another embodiment of the invention.

FIG. 5c is a detailed view of the container of FIG. 4 having been partially collapsed towards its base portion in accordance with another embodiment of the invention.

FIG. 6 is a side view of the container of FIG. 4 having been fully collapsed towards its base portion in accordance with another embodiment of the invention.

FIG. 6a is a top view of the container of FIG. 4 laving been fully collapsed towards its base portion in accordance with another embodiment of the invention.

FIG. 6b is a detailed exploded view of the interior of the container of FIG. 4 having been fully collapsed towards its base portion in accordance with another embodiment of the invention.

FIG. 7 is a side view of a container in expanded form in accordance with another embodiment of the invention.

FIG. 7a is a top view of the container in expanded form of FIG. 7 in accordance with another embodiment of the invention.

FIG. 7b is a detailed exploded view of the interior of a container in expanded form of FIG. 7 in accordance with another embodiment of the invention.

FIG. 7c is a detailed view of a container in expanded form of FIG. 7 in accordance with another embodiment of the invention.

FIG. 8 is a side view of the container of FIG. 7 having been partially collapsed towards its base portion in accordance with another embodiment of the invention.

FIG. 8a is a top view of the container of FIG. 7 having been partially collapsed towards its base portion in accordance with another embodiment of the invention.

FIG. 8b is a detailed view of the container of FIG. 7 having been partially collapsed towards its base portion in accordance with another embodiment of the invention.

FIG. 8c is a detailed view of the container of FIG. 7 having been partially collapsed towards its base portion in accordance with another embodiment of the invention.

FIG. 9 is a side view of the container of FIG. 7 having been fully collapsed towards its base portion in accordance with another embodiment of the invention.

FIG. 9a is a top view of the container of FIG. 7 having been fully collapsed towards its base portion in accordance with another embodiment of the invention.

FIG. 9b is a detailed exploded view of the interior of the container of FIG. 7 having been fully collapsed towards its base portion in accordance with another embodiment of the invention.

FIG. 10 is a side view of a container in expanded form in accordance with another embodiment of the invention.

FIG. 10a is a top view of the container in expanded form of FIG. 10 in accordance with another embodiment of the invention.

FIG. 10b is a detailed exploded view of the interior of a container in expanded form of FIG. 10 in accordance with another embodiment of the invention.

FIG. 10c is a detailed view of a container in expanded form of FIG. 10 in accordance with another embodiment of the invention.

FIG. 11 is a side view of the container in expanded form of FIG. 1 in accordance with the preferred embodiment of the invention containing a fluid.

FIG. 11a is a top view of the container in expanded form of FIG. 1 in accordance with the preferred embodiment of the invention containing a fluid.

FIG. 11b is a detailed exploded view of the interior of the container in expanded form of FIG. 1 in accordance with a preferred embodiment of the invention containing a fluid.

FIG. 11c is a detailed exploded view of the interior of the container in expanded form of FIG. 1 in accordance with the preferred embodiment of the invention containing a fluid.

FIG. 12 is a side view of the container of FIG. 1 having been partially collapsed towards its base portion and provided with a teat element in accordance with another embodiment of the invention.

FIG. 12a is a top view of the container of FIG. 1 having been partially collapsed towards its base portion and provided with a teat element in accordance with another embodiment of the invention.

FIG. 12b is a detailed view of the container of FIG. 1 having been partially collapsed towards its base portion and provided with a teat element in accordance with another embodiment of the invention.

FIG. 12c is a detailed view of the container of FIG. 1 having been partially collapsed towards its base portion and provided with a teat element in accordance with another embodiment of the invention.

### DETAILED DESCRIPTION

For a more detailed description of the present invention, reference is made to the Figures.

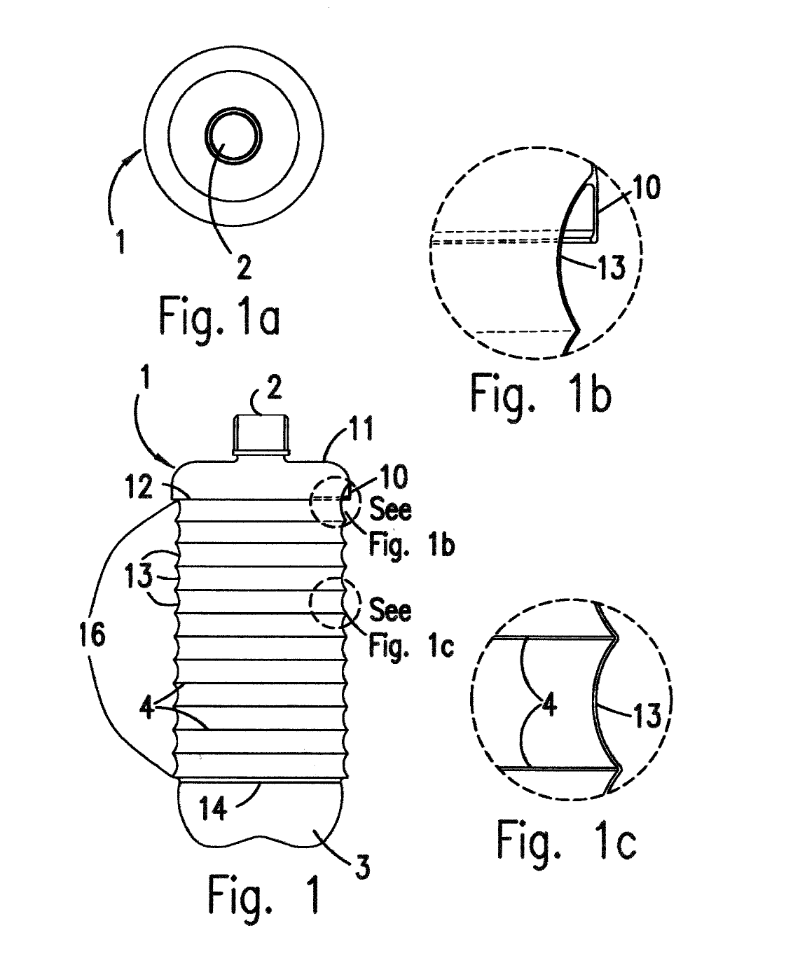

FIG. 1 is a side view of a container in expanded form in accordance with the preferred embodiment of the invention. The invention shown in FIG. 1 includes a container 1 in the shape of a bottle having a circular cross-sectional shape and a height dimension which is substantially greater than its cross-sectional dimension. Container 1 further has a top portion 11, provided with a lip 2, also of circular cross-sectional shape, for receiving or dispensing a product from the container, a lower edge 12 and locking and securing means in the form of overhang clip section 10 located on the top portion 11, a body portion 16 having a plurality of inwardly facing convex wall configurations 13, i.e. inwardly facing convex toward the vertical centre-line of the container 1. The inwardly facing convex wall configurations 13 lie between horizontal inclusion scored corrugations 4, a body lower edge 14 and a base portion 3 of container 1. The horizontal inclusion scored corrugations 4 and inwardly facing convex wall configurations 13, located in the body portion 16, are constructed to allow and enable the container 1 to collapse, if desired, in a top to bottom manner between the lower edge 12 of the top portion 11 and the top edge 14 of the lower base portion 3. Container 1 is further constructed such that when container 1 is in a fully expanded form, it can contain or hold a maximum amount of fluid or liquid. Container 1 is further composed and constructed of either plastic, paper, or similar materials and is also constructed to contain a product, usually liquids; however the product could be a solid such as a powder or pellet material such as pills, capsules or similar substances. Additionally, a cap is envisioned for use with container 1, to be secured to lip 2 by conventional means such as by screw threads or snap constructions. Further, the cap may comprise a traditional cap or may comprise special features as desired by a user; for example, a teat cap for allowing sipping or sucking of a liquid from container 1.

Now referring to FIG. 1a, a top view of the container 1 in expanded form of FIG. 1 is shown in accordance with the preferred embodiment of the invention and as can be seem from FIG. 1a, container 1 has a circular cross sectional shape and lip 2, provided for dispensing a product, is also of a circular cross sectional shape.

Now referring to FIG. 1b, a detailed exploded view of the interior of the container in expanded form of FIG. 1 in accordance with a preferred embodiment of the invention is shown. Particularly in FIG. 1b, the configuration of the overhang clip section 10, of top portion 11, is shown in relation to inwardly facing convex wall configurations 13 of body portion 16.

Now referring to FIG. 1c, a detailed view of the container in expanded form of FIG. 1 in accordance with the preferred embodiment of the invention. Particularly in FIG. 1c, the configuration of the horizontal inclusion scored corrugations 4 are shown in relation to inwardly facing convex wall configurations 13 of body portion 16.

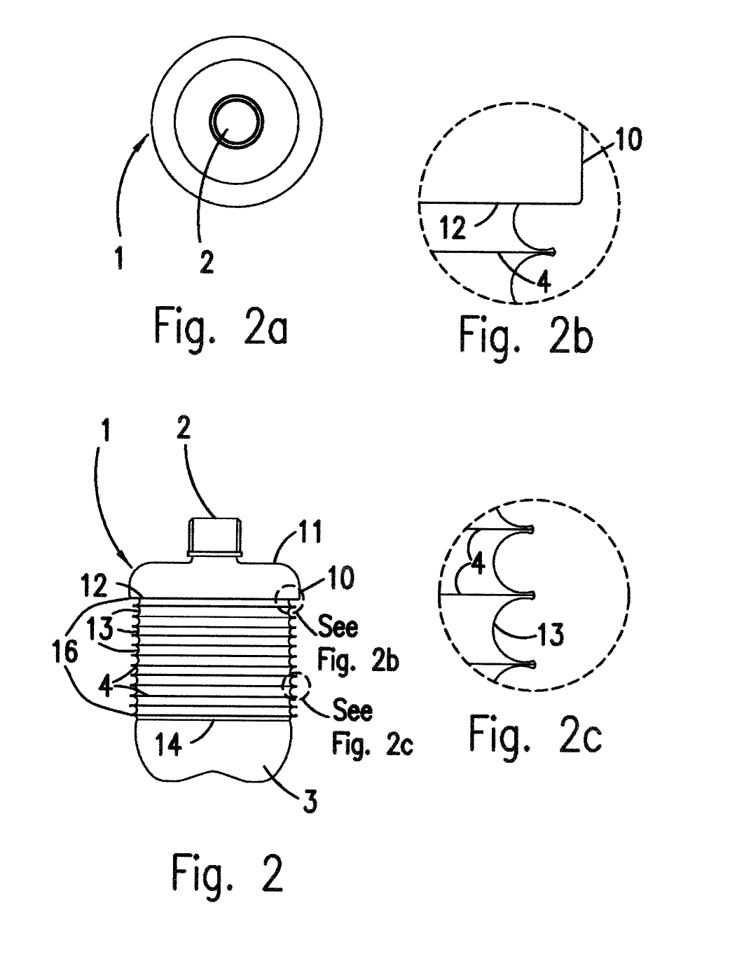

FIG. 2 is a side view of the container of FIG. 1 having been partially collapsed towards its base portion in accordance with a preferred embodiment of the invention.

Now referring to FIG. 2a, a top view of the container 1 of FIG. 1 having been partially collapsed towards its base portion in accordance with the preferred embodiment of the invention. As is seem from FIG. 2a, the circular cross-sectional nature of container 1 is maintained during the partial collapse of the container.

Now referring to FIG. 2b, a detailed view of the container of FIG. 1 having been partially collapsed towards its base portion is shown in accordance with the preferred embodiment of the invention. As is seem from FIG. 2b, as container 1 is collapsed, the inwardly facing convex wall configurations 13 become more acuate and the edges of horizontal inclusion scored corrugations 4 become more prominent as they extend outward and begin to nest under the edge 10 of container top portion 11.

Now referring to FIG. 2c, a detailed view of the container of FIG. 1 having been partially collapsed towards its base portion is shown in accordance with the preferred embodiment of the invention. As is seem from FIG. 2c, as container 1 is collapsed, the inwardly facing convex wall configurations 13 become more acuate and the edges of the horizontal inclusion scored corrugations 4 become more prominent as they extend outward.

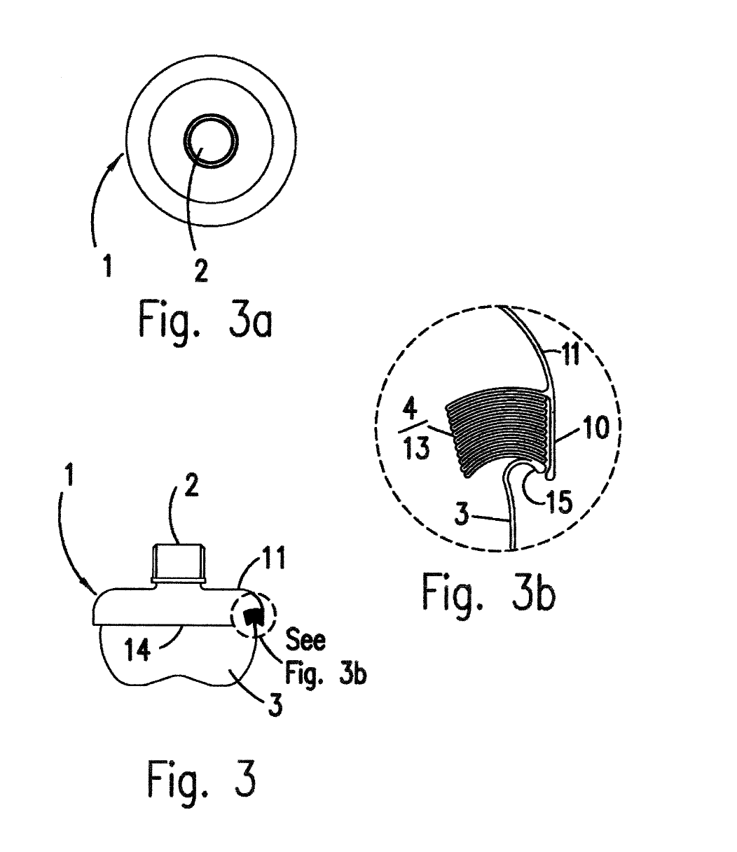

FIG. 3 is a side view of the container of FIG. 1 having been fully collapsed towards its base portion in accordance with the preferred embodiment of the invention. The preferred form of the invention shown in FIG. 3 includes a container 1 in a totally collapsed configuration such that the inwardly facing convex wall configurations 13 of body portion 16, between horizontal inclusion scored corrugations 4 are completely reduced in size vertically with the edges of horizontal inclusion scored corrugations 4 extending outwardly.

Now referring to FIG. 3a, a top view of the container 1 of FIG. 3 having been partially collapsed towards its base portion in accordance with the preferred embodiment of the invention is shown. As is seem from FIG. 3a, the circular cross-sectional nature of container 1 is maintained even with the complete collapse of the container.

Now referring to FIG. 3b, a detailed exploded view of the container of FIG. 3 having been completely collapsed towards its base portion is shown in accordance with the preferred embodiment of the invention. As is seem from FIG. 3b, as container 1 is totally collapsed, the inwardly facing convex wall configurations 13 completely nest together and the outer edges of scored corrugations 4 collapse together and rest on outer edge 15 integrally formed with base portion 3 and abut the inside edge 10 of container top portion 11. Additionally as the configurations 13 and scored horizontal inclusion corrugations 4 collapse and nest together, to become nest structure 4/13, edge 15, on the top portion of base portion 3 resiliently clips under the bottom tip of inside edge 10 to thereby secure nest structure 4/13 to container top portion 11.

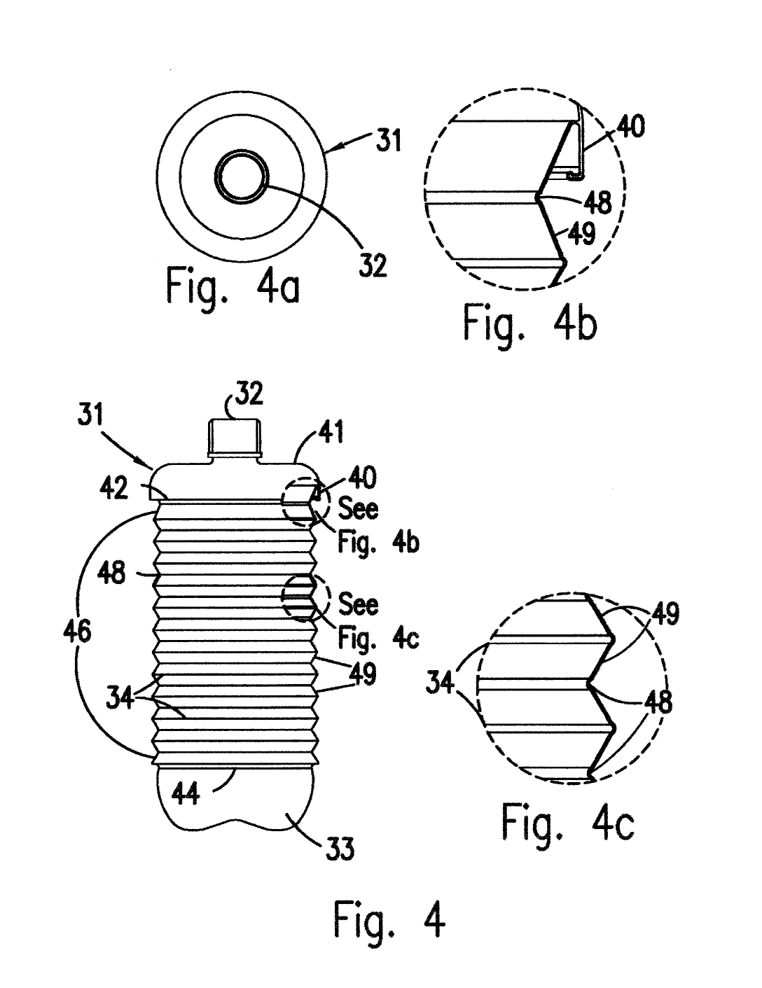

FIG. 4 is a side view of a container in expanded form in accordance with another embodiment of the invention. The invention shown in FIG. 4 includes a container 31 in the shape of a bottle having a similar circular cross-sectional shape and dimensions as container 1 of FIGS. 1-3. Container 31 also has a top portion 41 provided with a lip 32 also of circular cross-sectional shape, for receiving or dispensing a product from the container, a lower edge 42 and locking and securing means in the form of overhang clip section 40 located on the top portion 41, a body portion 46 having a plurality of inwardly facing linear wall configurations 49, i.e. inwardly facing toward the vertical centre-line of the container 31. The inwardly facing inclined linear wall configurations 49 lie between horizontal inclusions scored corrugations 34, a body lower edge 44 and a base portion 33. The horizontal inclusion scored corrugations 34 and inwardly facing inclined linear wall configurations 49, located in the body portion 46, are constructed to allow and enable the container 31 to collapse, if desired, in a top to bottom manner between the lower edge 42 of the top portion 41 and the top edge 44 of the lower base portion 33. Further, inwardly inclined linear wall configurations 49 are provided with concave structures 48 located on the outer edges of horizontal inclusions scored corrugations 34 to assist in the collapsing of the container 31. Container 31 is constructed such that its height dimension is substantially greater than its circular dimension and when container 31 is in a fully expanded form it can contain or hold a maximum amount of fluid or liquid. The container 31 is further composed and constructed of similar materials of that of container 1 of FIGS. 1-3 and also constructed, as container to contain similar or the same materials as that of container 1. Additionally, a same or similar cap is envisioned for use with container 31, to be secured to lip 32 by conventional means such as by screw threads or snap constructions. Further, the cap may comprise a traditional cap or may comprise special features as desired by a user; for example, a teat cap, for allowing sipping or sucking of a liquid from container 31.

Now referring to FIG. 4a, a top view of the container 31 in expanded form of FIG. 4 is shown can be seem from FIG. 4a, container 31 has a circular cross section and lip 32, for dispensing a product, is also of a circular cross sectional shape.

Now referring to FIG. 4b, a detailed exploded view of the interior of the container in expanded form of FIG. 4 is shown. Particularly in FIG. 4b, the configuration of the overhang clip section 40, of top portion 41, is shown in relation to inwardly facing linear wall configurations 49 and concave structures 48 of horizontal inclusion scored corrugations 34 all of body portion 46 of FIG. 4.

Now referring to FIG. 4c, a detailed view of the container in expanded form of FIG. 4 is shown. Particularly in FIG. 4c, the configuration of the horizontal inclusion scored corrugations 34 and concave structures 48 are shown in relation to inwardly facing linear inclined wall configurations 49 of body portion 46 of FIG. 4.

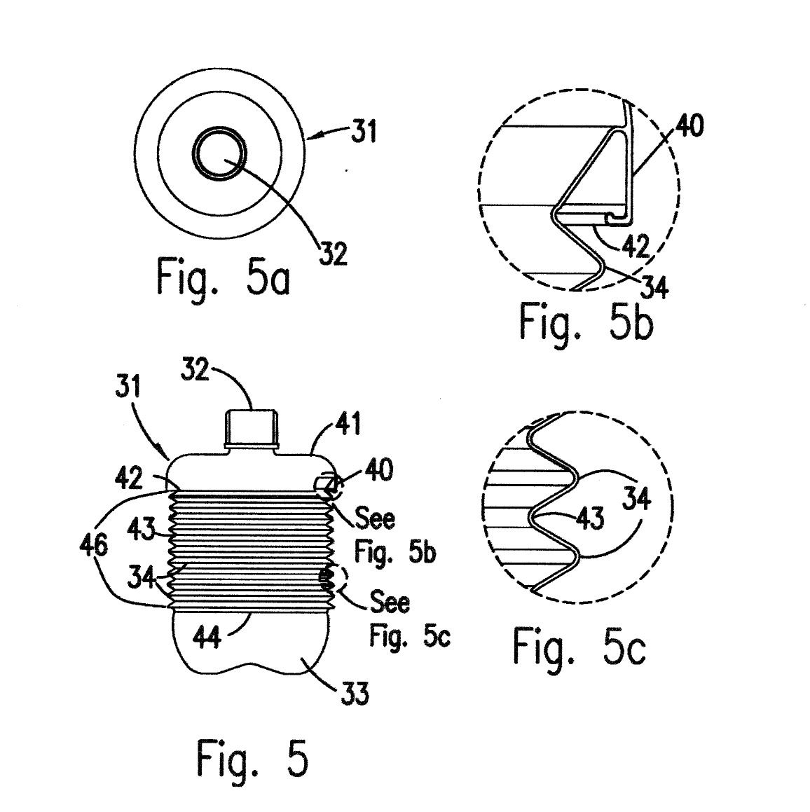

FIG. 5 is a side view of container 31 of FIG. 4 having been partially collapsed towards its base portion 33. Referring to FIG. 5a, a top view of the container 31 of FIG. 4 having been partially collapsed towards its base portion 33 is shown. As is seem from FIG. 5a, the circular cross-sectional nature of container 31 is maintained during the partial collapse of the container.

Now referring to FIG. 5b, a detailed view of container 31 of FIG. 4 having been partially collapsed towards its base portion is shown. As is seen from FIG. 5b, as container 31 is collapsed, the inwardly facing convex wall configurations 43 become more acuate and the edges of scored corrugations 34 become more prominent as they extend outwardly and begin to nest under the edge 40 of container top portion 41 of FIG. 5.

Now referring to FIG. 5c, a detailed view of container 31 of FIG. 4 having been partially collapsed towards its base portion 33 is shown. As is seen from FIG. 5c, as container 31 is collapsed, the inwardly facing convex wall configurations 43 become more acuate and the edges of horizontal inclusion scored corrugations 34 become more prominent as they extend outward.

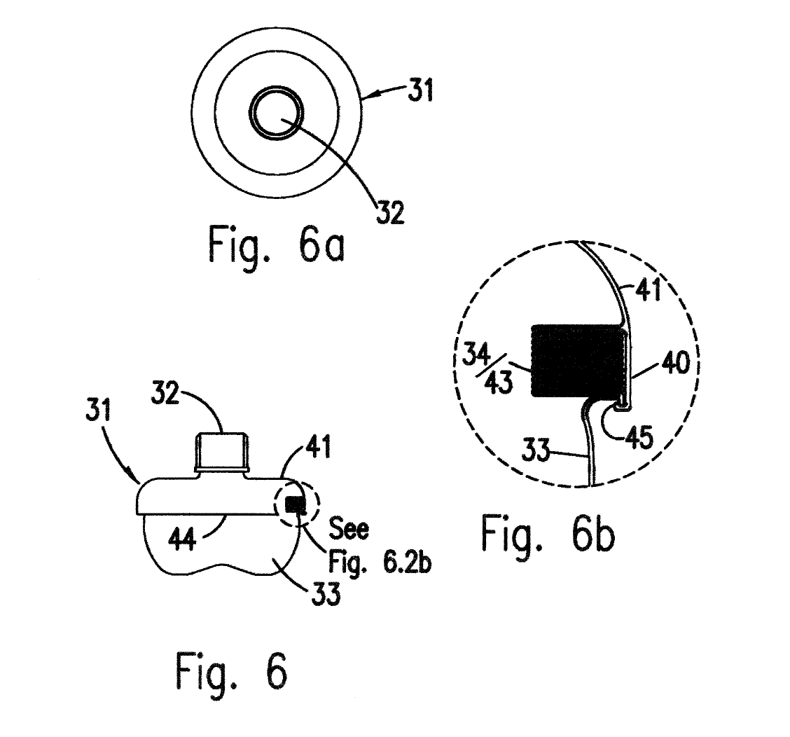

FIG. 6 is a side view of container 31 of FIG. 4 having been fully collapsed towards its base portion 33 and shows in a totally collapsed configuration the inwardly facing convex wall configurations 43 of body portion 46, between horizontal inclusion scored corrugations 34 are completely reduced in size vertically with the edges of scored corrugations 34 extending outward.

Now referring to FIG. 6a, a top view of container 31 of FIG. 4 having been fully collapsed towards its base portion 33 and as is seen from FIG. 6a, the circular cross-sectional nature of container 31 is maintained even with the complete collapse of the container.

Now referring to FIG. 6b, a detailed exploded view of container 31 of FIG. 4 having been completely collapsed towards its base portion 33 is shown. As is seen from FIG. 6b, as container 31 is totally collapsed, the inwardly facing convex wall configurations 43 completely nest together and the outer edges of scored corrugations 34 collapse together to become nest structure 34/43 and rest on outer edge 45 integrally formed with base portion 33 and abut the inside edge 40 of container top portion 41. Additionally as the configurations 43 and scored corrugations 34 collapse and nest together, edge 45 resiliently clips under the bottom tip of inside edge 40 to thereby secure the nest structure 34/43 to container top portion 41.

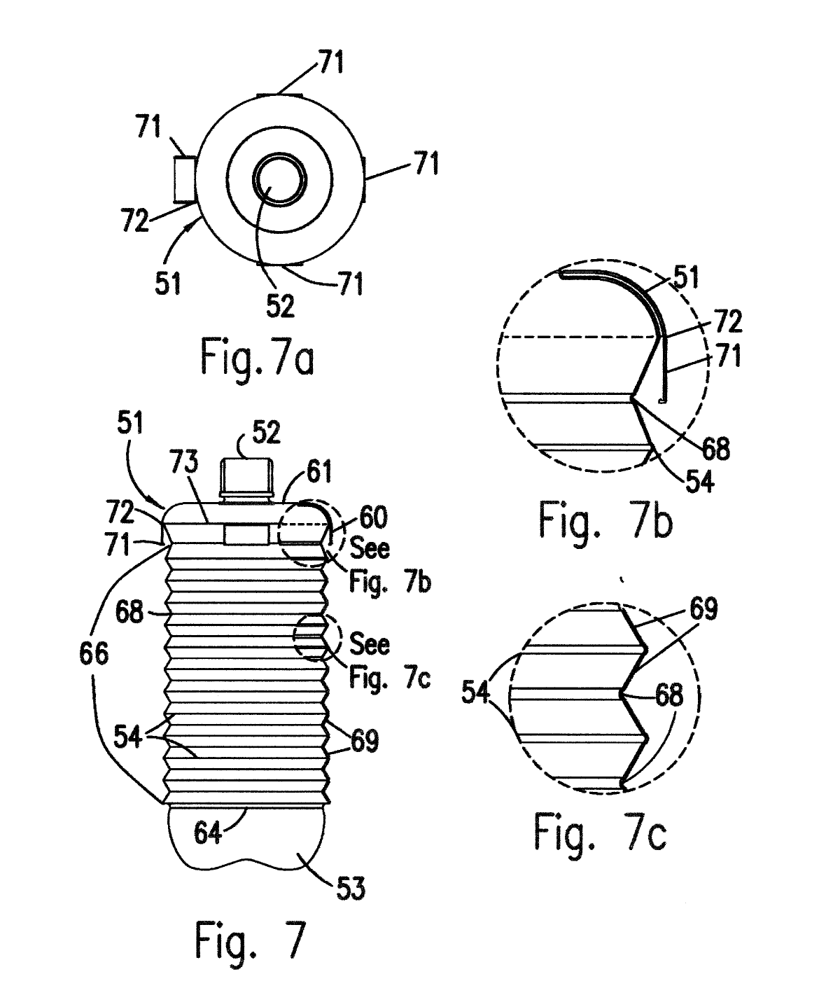

FIG. 7 is a side view of a container in expanded form in accordance with another embodiment of the invention. The invention shown in FIG. 7 includes a container 51 in the shape of a bottle having a similar circular cross-sectional shape and dimensions as container 1 of FIGS. 1-3 and container 31 of FIGS. 4-6. Container 51 also has a top portion 61 provide with a lip 52, also of circular cross-sectional shape, for receiving or dispensing a product, a body portion 66, inwardly facing inclined linear wall configurations 69, horizontal scored corrugations 54, body lower edge 64, and base portion 53. Additionally, container 51 is provided with a top portion 61 which is provided with locking and securing means in the form of four hinged clip structures 71 attached to and equally spaced on top portion 61. Clip structures 71 allow and enable the container 51 to collapse, if desired, in a top to bottom manner between the lower edge 73 of the top portion 61 and the top edge 64 of the lower base portion 53 all located on container 51. Additionally, horizontal scored corrugations 54 are formed with concave configurations 68 to further facilitate collapsing of container 51. Container 51 is further constructed, similar to containers 1 and 31, such that its height dimension is substantially greater than its circular dimension and when container 51 is in a fully expanded form it can contain or hold a maximum amount of fluid or liquid. The container 51 is further composed and constructed of similar materials and can contain similar or the same materials as that of container 1 of FIGS. 1-3 and container 31 of FIGS. 4-6. Likewise, cap structures envisioned for use with containers 1 and 31 are envisioned to be used with container 51. Clip structures 71 are composed of the same material as container 51 and are capable of moving from a vertical closed position to an outward open position to affect the clipping of collapsed inwardly facing linear inclined wall configurations 69 when container 51 is completely collapsed. To effect the collapsing of container 51, a user will press down on lip 52 to begin collapsing of container 51, while pulling out dip structures 71. When container 51 is completely collapsed, and as horizontal scored corrugations 54 and configurations 69 nest together, the user will push clip structures 71 toward container 51 securing collapsed configurations 69.

Now referring to FIG. 7a, a top view of container 51 in expanded form of FIG. 7 is shown in accordance another embodiment of the invention and as can be seem from FIG. 7a, container 51 has a circular cross section lip 52, for dispensing a product, likewise the entire container has a circular cross sectional shape. Additionally, a clip structure 71, on the left most side of the top view of FIG. 7a is shown in an outward extended position as an example of the function of clip 71.

Referring to FIG. 7b, a detailed exploded view of the interior of container 51 in expanded form of FIG. 7 is shown. Particularly in FIG. 7b, the configuration of the clip structures 71 and hinge sections 72 of top portion 61, is shown in relation to inwardly facing linear inclined wall configurations 69, the horizontal scored corrugations 54 and concave configurations 68 of body portion 66.

Now referring to FIG. 7c, a detailed view of container 51 in expanded form of FIG. 7 is shown. Particularly in FIG. 7c, the configuration of the horizontal inclusion scored corrugations 54 with concave configurations 68 are shown in relation to inwardly facing linear inclined wall configurations 69 of body portion 66.

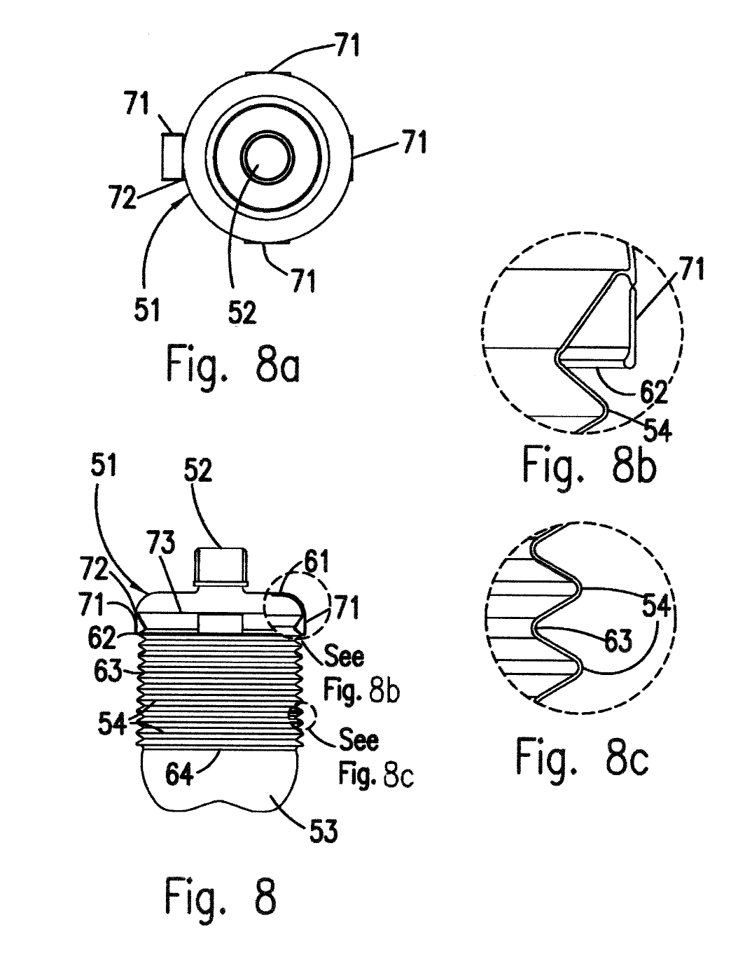

FIG. 8 is a side view of container 51 of FIG. 7 having been partially collapsed towards its base portion 53. Referring to FIG. 8a, a top view of container 51 of FIG. 7 having been partially collapsed towards its base portion 53 is shown and as is seen from FIG. 8a, the circular cross-sectional nature of container 51 is maintained during the partial collapse of container 51.

Now referring to FIG. 8b, a detailed view of container 51 of FIG. 7 having been partially collapsed towards its base portion 53 is shown an as is seen from FIG. 7b, as container 51 is collapsed, the inwardly facing linear inclined wall configurations 69 become more acuate and the edges of scored corrugations 54 become more prominent as they extend outward and begin to nest under the edge 62 of container top portion 61.

Now referring to Figure Sc, a detailed view of container 51 of FIG. 7 having been partially collapsed towards its base portion 53 and as is seen from FIG. 8c, as container 51 is collapsed, the inwardly facing inclined configurations 63 become more acuate and the edges of scored corrugations 54 become more prominent as they extend outwardly.

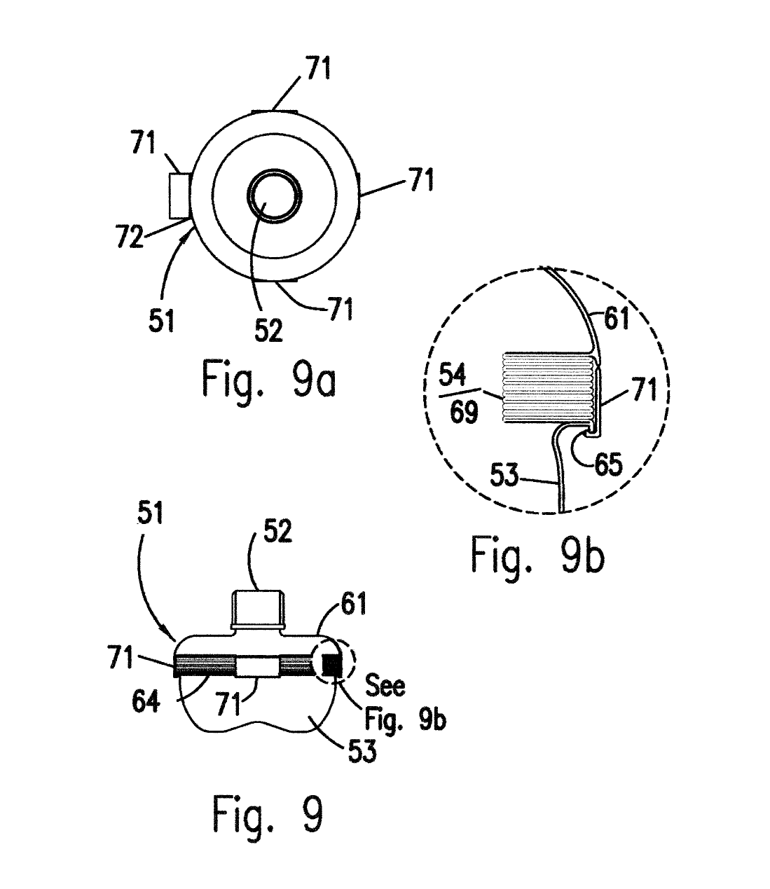

FIG. 9 is a side view of container 51 of FIG. 7 having been fully collapsed towards its base portion 53 and as is shown in FIG. 9, container 31 is in a totally collapsed configuration such that inwardly facing linear inclined wall configurations 69 of body portion 66, between horizontal inclusion scored corrugations 54 are completely reduced in size vertically with the edges of scored corrugations 54 extending fully outward. Referring to FIG. 9a, a top view of container 51 of FIG. 7 having been fully collapsed towards its base portion 53 is shown and as is seen from FIG. 9a, the circular cross-sectional nature of container 51 is maintained even with the complete collapse of the container and one of the hinges 71, on the left hand side, being shown in an extended manner.

Now referring to FIG. 9b, a detailed view of container 51 of FIG. 7 having been completely collapsed towards its base portion 53 is shown and as is seen from FIG. 9b, as container 51 is totally collapsed, the inwardly facing linear inclined wall configurations 69 completely nest together and the outer edges of scored corrugations 54 collapse together to become nest structure 54/69 and rest on outer edge 65 integrally formed with base portion 53 and abut the inside edge of container top portion 61 and dip structures 71 are pushed inward toward container 51 to secure collapsed configurations 69.

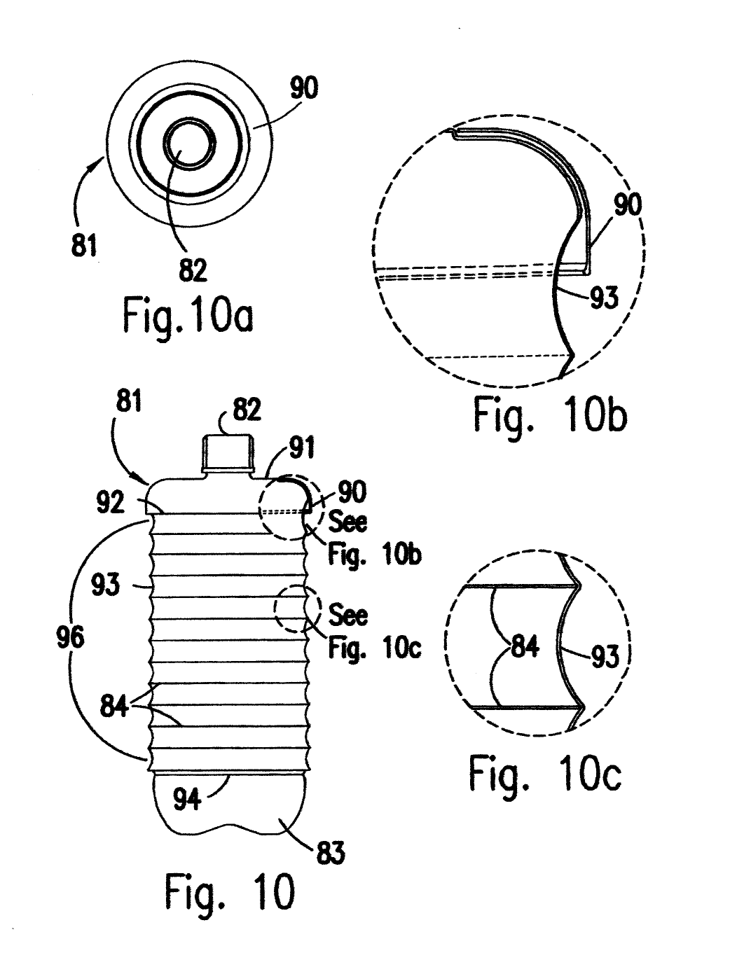

FIG. 10 is a side view of a container in expanded form in accordance with another embodiment of the invention. The invention shown in FIG. 10 includes a container 81 in the shape of a bottle whose lip 82, body portion 96, inwardly facing convex wall configurations 93, horizontal scored corrugations 84, body lower edge 94, and base portion 83 which are identical in construction to the same parts of container 1 of FIG. 1. However, container 81 of FIG. 10 has an alternative top portion 91 structure with locking and securing means in the form of a removable clip 90 which is mountable on top portion 91 and is provided with means to allow and enable the container 81 to collapse, if desired, in a top to bottom manner between the lower edge 92 of the top portion 91 and the top edge 94 of the lower base portion 83. Container 81 is farther constructed having a similar circular cross-sectional shape and dimensions as container 1 of FIGS. 1-3, container 31 of FIGS. 4-6 and container 51 of FIGS. 7-9. Container 81 is further constructed, similar to containers 1, 31, and 51 such that its height dimension is substantially greater than its circular dimension and when container 81 is in a fully expanded form, it can contain or hold a maximum amount of product. The container 81 is further composed and constructed of similar materials and can contain similar or the same materials as that of containers 1, 31, or 51. Likewise, cap structures envisioned for use with containers 1, 31, and 51 are envisioned to be used with container 81.

Now referring to FIG. 10a, a top view of the container 81 in expanded form of FIG. 10 is shown and as can be seen from FIG. 10a, container 81 has a circular cross section lip 82, for dispensing a product. Likewise container 81 has a circular cross sectional shape and removable clip structure 90 which also is of a circular cross sectional shape. Container 81 is also constructed to collapse, partially and fully, as previously disclosed with container 1, in FIGS. 1-3, and as container 81 is collapsed, inwardly facing convex wall configurations 93, horizontal scored corrugations 84 collapse and nest and secure together under clip structure 90.

Now referring to FIG. 10b, a detailed exploded view of the interior of container 81 in expanded form of FIG. 10 is shown. Particularly in FIG. 10b, the configuration of the overhang dip section 90, of top portion 91, is shown in relation to inwardly facing convex wall configurations 93 and horizontal scored corrugations 84 of body portion 96.

Now referring to FIG. 10c, a detailed view of container 81 in expanded form of FIG. 10 and particularly in FIG. 10c, the configuration of the horizontal inclusion scored corrugations 84 are shown in relation to inwardly facing convex wall configurations 93 of body portion 96.

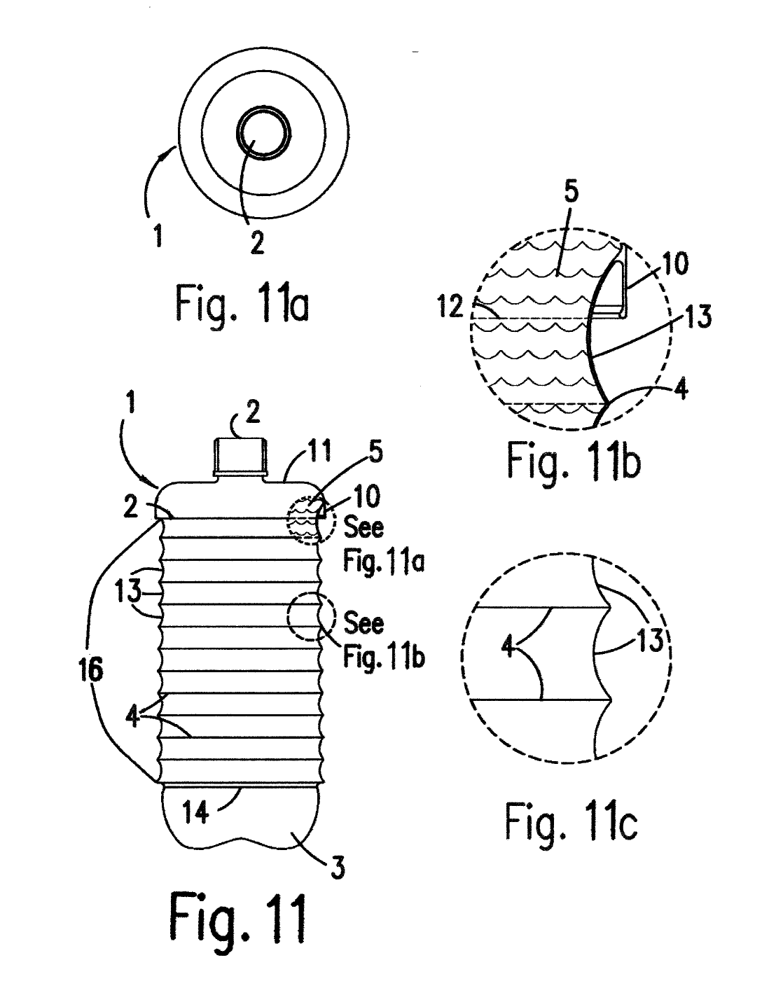

FIG. 11 is a side view of the container of FIG. 1 in expanded form in accordance with the preferred embodiment of the invention containing a product such as a liquid. The preferred form of the invention shown in FIG. 11 is the same as container 1 in FIGS. 1-3, a top portion 11 having a lip 2, for receiving or dispensing a fluid or liquid, a lower edge 2 and overhang clip section 10, a body portion 16 having a plurality of inwardly facing convex wall configurations 13 between horizontal inclusion scored corrugations 4, a body lower edge 14 and a base portion 3. The horizontal inclusion scored corrugations 4 and inwardly facing convex wall configurations 13, located in the body portion 16 are constructed to allow and enable the container 1 to collapse, if desired, in a top to bottom manner between the lower edge 12 of the top portion 11 and the top edge 14 of the lower base portion 3. Referring further to FIG. 11, the container 1 contains fluid product 5, usually a liquid. Examples of products of this type may include but are unrestricted to water, flavoured drinks including e.g. milk, soft drink, sodas, tea or pharmaceuticals, etc.; however the product could be a solid such as a powder or pellet material such as pills, capsules or similar substances.

Now referring to FIG. 11a, a top view of the container 1 in expanded form of FIG. 11 is shown in accordance with the preferred embodiment of the invention. It is seem from FIG. 11a, that the container 1 has a circular cross section, and lip 2 likewise has a circular cross section.

Now referring to FIG. 11b, a detailed exploded view of the interior of container 1 in expanded form of FIG. 1 is shown. Particularly in FIG. 11b, the configuration of the overhang clip section 10, of top portion 11, is shown in relation to inwardly facing convex wall configurations 13 of body portion 16. Referring further to FIG. 11b, the container 1 contains fluid product 5, usually a liquid as previously described.

Now referring to FIG. 11c, a detailed view of container 1 in expanded form of FIG. 1 is shown and particularly in FIG. 11e, the configuration of the horizontal inclusion scored corrugations 4 are shown in relation to inwardly facing convex wall configurations 13 of body portion 16. Additionally, FIG. 11c shows the outwardly scored convex wall structure of scored corrugations 4, on body portion 16, i.e. scored corrugations 4 which are convexly constructed outwardly from the vertical centreline of the container 1.

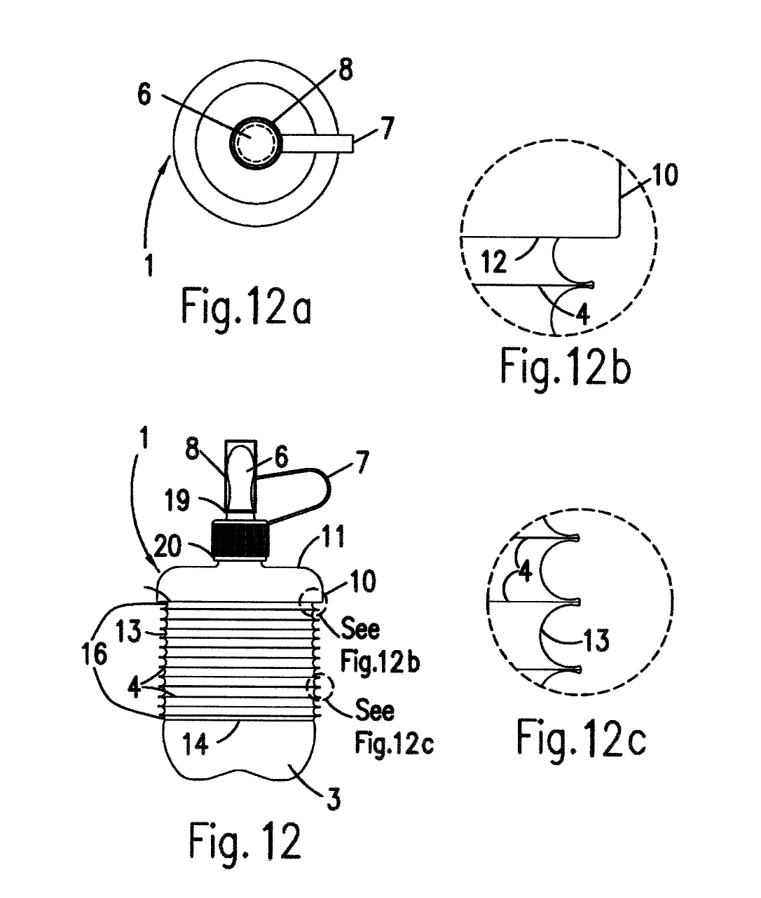

FIG. 12 is a side view of the container of FIG. 2 having been partially collapsed towards its base portion in accordance with the embodiment of the invention and having an addition feature. The container of FIG. 12 includes all of the features of the container 1 of FIG. 2, i. e. a top portion 11 having a lower edge 12 and overhang clip section 10, a body portion 16 having inwardly facing convex wall configurations 13, horizontal inclusion scored corrugations 4, a body lower edge 14 and a base portion 3. As previously described, when container 1 is in its fully expanded form, it can contain and hold a maximum amount of fluid or liquid. However, the container 1 of FIG. 12, is provided with a different detachable and removable teat element 19 which is attachable in any conventional manner, for example by a screw or a snap closure element 20 to the container 1. Teat element 19 is provided with a teat or nipple feature 6, a cap 8 and flexible tether connector 7 attaching cap 8 to teat element 19. The teat or nipple feature 6 allows for drinking by sipping or sucking by a container 1 user. It is further envisioned that in addition to container 1, all of the containers disclosed here, i.e., containers 3, 51, and 81 could be provided with teat element 19, cap 8 and tether connector 7.

Now referring to FIG. 12a, a top view of container 1 of FIG. 1 having been partially collapsed towards its base portion 3 and including closure element 20 and teat element 19, the circular cross-sectional nature of container 1 is maintained.

Referring to FIG. 12b, a detailed view of container 1 provided with the closure element 20 and teat element 19 is shown wherein the collapsing nature of container 1 is maintained. Finally, referring to FIG. 12c, a detailed view of container 1 provided with closure element 20 and teat clement 19 having been partially collapsed towards its base portion 3 is shown wherein the collapsing capability of container 1 is maintained.

Having now described the construction of the embodiments of the invention, the use and/or operation thereof will be described. The container of the present invention is intended and capable of receiving, containing, holding, and dispensing various products, particularly liquids. As previously disclosed a typical liquid intended for use with the container 1 would be water and its use with the container will serve a typical example although the use would be the same for containers 31, 51, or 8. As shown in FIG. 1, the container 1, in its fully expanded form is capable of containing and holding a maximum amount of liquid and is also provided with a lip for receiving or dispensing a product to or from container 1. As shown in FIG. 4, container 1 is filled with liquid 5, and as the water is used and/or dispensed from container 1, the container may be made smaller and more compact by applying downward pressure to lip 2 and/or container top portion 11. As the water is completely used and/or dispensed, additional downward pressure can be applied to compress the container to its smallest size. At this point, the container may be easily disposed and by it construction and its ability to dramatically reduce in size, greatly assists in reducing volume in environmental waste disposal. Alternatively, container 1 may be retained in its collapsed position for later re-expansion and reuse.

Additionally, as disclosed in the alternative embodiment, the collapsible container 1 may be used with a lip comprising a teat or nipple allowing for the dispensing of the container product by sucking. As more of the product is dispensed, the container can be compressed to reduce its size in a manner as previously described. When the entire product has been dispensed the container can be completely collapsed for disposal or reuse.

The principles of the invention could be practiced by those of skilled in the art with equivalent alternative shapes. The invention may be embodied and practiced in other specific forms without departing from the spirit and essential characteristics thereof. The present embodiments are therefore to be considered in all respects as illustrative and not restrictive, the scope of the invention being indicated by the appended claims rather than by the foregoing description; and all variations, substitutions and changes which come within the meaning and range of equivalency of the claims are therefore intended to be embraced therein.

When introducing elements of the present invention or the preferred embodiment(s) thereof, the articles “a”, “an”, “the”, and “said” are intended to mean there are one or more of the elements. The terms “comprising”, “including”, and “having” are intended to be inclusive and mean that there may be additional elements other than the listed elements.

The preceding written description and the accompanying drawings are Intended solely as representative examples.

Only the appended claims and their equivalents define the scope of the protected invention.

The invention described herein is susceptible to variations, modifications and/or additions other than those specifically described and it is to be understood that the invention includes all such variations, modifications and/or additions which fall within the spirit and scope of the following claims

what is claimed:

1. A container for containing and dispensing a product, the container comprising
a top portion,
a body portion,
a base portion,
a locking and securement means,
wherein the top portion is provided with a lip and wherein the body portion is collapsible allowing the container to be in an expanded form or a collapsed form wherein the container may be compressed and collapsed once product is dispensed from the container by applying downward pressure to the container whereby when fully compressed and collapsed the container assists in alleviating environmental waste disposal issues by reducing the volume of waste and assists in the recycling process of waste material.

2. The container of claim 1 wherein the body portion is provided with a plurality of horizontal scored corrugations and inwardly facing convex wall configurations.

3. The container of claim 1 wherein the body portion is provided with a plurality of horizontal scored corrugations and inwardly facing linear wall configurations.

4. The container of claim 2 wherein the top portion is provided with a lower edge and wherein the locking and securement means comprises an overhang dip section having a bottom tip said dip section being located on the bottom of the top portion of the container.

5. The container of claim 2 wherein the top portion is provided with a lower edge and wherein the locking and securement means comprises a plurality of hinged clip structures attached to the sides of the top portion of the container.

6. The container of claim 2 wherein the top portion is provided with a lower edge and wherein the locking and securement means comprises a removable clip mountable on the top portion of the container.

7. The container of claim 3 wherein the top portion is provided with a lower edge and wherein the locking and securement means comprises an overhang dip section having a bottom tip said dip section being located on the bottom of the top portion of the container.

8. The container of claim 3 wherein the top portion is provided with a lower edge and wherein the locking and securement means comprises a plurality of hinged clip structures attached to the sides of the top portion.

9. The container of claim 3 wherein the top portion is provided with a lower edge and wherein the locking and securement means comprises removable clip mountable on the top portion.

10. The container of claim 4 wherein the base portion is provided with a body lower edge and wherein the horizontal inclusion scored corrugations and inwardly facing convex wall configurations, located in the body portion, are constructed to allow and enable the container to be in a fully expanded form or to be collapsed to a fully compact form by compressing the container in a top to bottom manner between the lower edge of the top portion and the top edge of the lower base by causing the inwardly facing convex wall configurations to reduce in size vertically and the horizontal inclusion scored corrugations enlarge in size horizontally outwardly and to nest vertically, as body portion collapses, and wherein the nested scored corrugations and configurations rest on an outer edge of base portion, and outer edge resiliently clips under the bottom tip of and into the overhang clip section to thereby lock and secure the nested scored corrugations to the container top portion and wherein the container is of a circular cross-section shape and wherein the vertical height of the container is substantially greater than its circular cross-sectional dimension.

11. The container of claim 5 wherein the base portion is provided with a body lower edge and wherein the horizontal inclusion scored corrugations and inwardly facing convex wall configurations, located in the body portion, are constructed to allow and enable the container to be in a fully expanded form or to be collapsed to a fully compact form by compressing the container in a top to bottom manner between the lower edge of the top portion and the top edge of the lower base by causing the inwardly facing convex wall configurations to reduce in size vertically and the horizontal inclusion scored corrugations enlarge in size horizontally outwardly and nest vertically, as body portion collapses, and wherein the nested scored corrugations and configurations rest on an outer edge, of base portion, and are locked and secured by the hinged clip structures attached to the sides of the top portion and wherein the container is of a circular cross-section shape and wherein the vertical height of the container is substantially greater than its circular cross-sectional dimension.

12. The container of claim 6 wherein the base portion is provided with a body lower edge and wherein the horizontal inclusion scored corrugations and inwardly facing convex wall configurations, located in the body portion, are constructed to allow and enable the container to be in a fully expanded form or to be collapsed to a fully compact form by compressing the container in a top to bottom manner between the lower edge of the top portion and the top edge of the lower base by causing the inwardly facing convex wall configurations to reduce in size vertically and the horizontal inclusion scored corrugations enlarge in size horizontally outwardly and nest vertically, as body portion collapses, and wherein the nested scored corrugations and configurations rest on an outer edge, of base portion, and are locked and secured by the removable clip mountable on the top portion and wherein the container is of a circular cross-section shape and wherein the vertical height of the container is substantially greater than its circular cross-sectional dimension.

13. The container of claim 7 wherein the base portion is provided with a body lower edge and wherein the horizontal inclusion scored corrugations and inward linear wall configurations, located in the body portion, are constructed to allow and enable the container to be in a fully expanded form or to be collapsed to a fully compact form by compressing the container in a top to bottom manner between the lower edge of the top portion and the top edge of the lower base by causing the inwardly facing linear wall configurations to reduce in size vertically and the horizontal inclusion scored corrugations enlarge in size horizontally outwardly and nest vertically, as body portion collapses, and wherein the nested scored corrugations and configurations rest on outer edge, of base portion, and outer edge resiliently clips under the bottom tip of and into the overhang clip section to thereby lock and secure the nested scored corrugations and configurations to the container top portion and wherein the container is of a circular cross-section shape and wherein the vertical height of the container is substantially greater than its circular cross-sectional dimension.

14. The container of claim 8 wherein the base portion is provided with a body lower edge and wherein the horizontal inclusion scored corrugations and inwardly facing linear wall configurations, located in the body portion, are constructed to allow and enable the container to be in a fully expanded form or to be collapsed to a fully compact form by compressing the container in a top to bottom manner between the lower edge of the top portion and the top edge of the lower base by causing the inwardly facing linear wall configurations to reduce in size vertically and the horizontal inclusion scored corrugations enlarge in size horizontally outwardly and nest vertically, as body portion collapses, and wherein the nested scored corrugations and configurations rest on outer edge of base portion, and are locked and secured by the hinged clip structures attached to the sides of the top portion and wherein the container is of a circular cross-section shape and wherein the vertical height of the container is substantially greater than its circular cross-sectional dimension.

15. The container of claim 9 wherein the base portion is provided with a body lower edge and wherein the horizontal inclusion scored corrugations and inwardly facing linear wall configurations, located in the body portion, are constructed to allow and enable the container to be in a fully expanded form or to be collapsed to a fully compact form by compressing the container in a top to bottom manner between the lower edge of the top portion and the top edge of the lower base by causing the inwardly facing linear wall configurations to reduce in size vertically and the horizontal inclusion scored corrugations enlarge in size horizontally outwardly and nest vertically, as body portion collapses, and wherein the nested scored corrugations and configurations rest on outer edge of base portion, and are locked and secured by the removable clip mountable on the top portion and wherein the container is of a circular cross-section shape and wherein the vertical height of the container is substantially greater than its circular cross-sectional dimension.

16. The container of claim 2 wherein the container is in the shape of a bottle and the wherein lip is of a circular cross-sectional shape and wherein the container is further provided with a detachable and removable teat element attachable by a screw or a snap closure element to the container wherein teat element is provided with a teat or nipple feature, a cap and flexible tether connector attaching cap to teat element and wherein the teat or nipple feature allows for drinking by sucking by a container user and wherein and wherein the container is capable of receiving and containing a product in fluid form and wherein the product can be a gas, solid or liquid and wherein the product in a liquid form consists of and unrestricted to water, flavoured drinks, milk, soft drinks, sodas, tea and pharmaceutical products and wherein the container in a fully expanded form can contain a maximum amount of fluid or liquid and wherein the container may be partially collapsed as the product is dispensed may continue to be used and further collapsed as the product is dispensed and wherein the container is constructed to be stored in a collapsed fully compact form.

17. The container of claim 3 wherein the container is in the shape of a bottle and the wherein lip is of a circular cross-sectional shape and wherein the container is further provided with a detachable and removable teat element attachable by a screw or a snap closure element to the container wherein teat element is provided with a teat or nipple feature, a cap and flexible tether connector attaching cap to teat element and wherein the teat or nipple feature allows for drinking by sucking by a container user and wherein and wherein the container is capable of receiving and containing a product in fluid form and wherein the product can be a gas, solid or liquid and wherein the product in a liquid form consists of and unrestricted to water, flavoured drinks, milk, soft drinks, sodas, tea and pharmaceutical products and wherein the container in a fully expanded form can contain a maximum amount of fluid or liquid and wherein the container may be partially collapsed as the product is dispensed may continue to be used and further collapsed as the product is dispensed and wherein the container is constructed to be stored in a collapsed fully compact form.

18. The container of claim 1 wherein the container is in the shape of a bottle and the wherein lip is of a circular cross-sectional shape and wherein the container is further provided with a detachable and removable teat element attachable by a screw or a snap closure element to the container wherein teat element is provided with a teat or nipple feature, a cap and flexible tether connector attaching cap to teat element and wherein the teat or nipple feature allows for drinking by sucking by a container user and wherein and wherein the container is capable of receiving and containing a product in fluid form and wherein the product consists of a gas, solid or liquid and wherein the product in a liquid form consists of and unrestricted to water, flavoured drinks, milk, soft drinks, sodas, tea and pharmaceutical products and wherein the container in a fully expanded form can contain a maximum amount of fluid or liquid and wherein the container may be partially collapsed as the product is dispensed may continue to be used and further collapsed as the product is dispensed and wherein the container is constructed to be stored in a collapsed fully compact form.

19. A container in the shape of a bottle for containing and dispensing a product comprising
a top portion provided with a lip for receiving or dispensing a product from the container wherein the top portion is provided with a lower edge and overhang dip section having a bottom tip, and wherein the container has a vertical centre-line, and
a body portion having a plurality of inwardly facing convex wall configurations, which are convex toward the vertical centre-line of the container and wherein the inwardly facing convex wall configurations lie between horizontal inclusion scored corrugations located on the body portion, and
a base portion having a body lower edge and wherein the horizontal inclusion scored corrugations and inwardly facing convex wall configurations, located in the body portion, are constructed to allow and enable the container to be in a fully expanded form or to be collapsed to a fully compact form by compressing the container in a top to bottom manner between the lower edge of the top portion and the top edge of the lower base by causing the inwardly facing convex wall configurations to reduce in size vertically and the horizontal inclusion scored corrugations enlarge in size horizontally outwardly and nest vertically, as body portion collapses, and wherein the nested scored corrugations rest on outer edge, of base portion, and outer edge resiliently clips under the bottom tip of and into the overhang clip section to thereby secure the nested scored corrugations to the container top portion and wherein the container is of a circular cross-section shape and wherein the vertical height of the container is substantially greater than its circular cross-sectional dimension and wherein the container and the lip is of a circular cross-sectional shape and wherein the container is further provided with a detachable and removable teat element attachable by a screw or a snap closure element to the container wherein teat element is provided with a teat or nipple feature, a cap and a flexible tether connector attaching cap to teat element and wherein the teat or nipple feature allows for drinking by sucking by a container user and wherein
the container is capable of receiving and containing a product in fluid form and wherein the product can be a gas, solid or liquid and wherein the product may consist of a liquid unrestricted to water, flavoured drinks, milk, soft drink, sodas, tea, and pharmaceutical products and wherein the container in a fully expanded form can contain a maximum amount of fluid or liquid and wherein the container may be partially collapsed as the product is dispensed may continue to be used and further collapsed as the product is dispensed and wherein
the container is constructed to be stored in a collapsed fully compact form reducing storage requirements thereof or assists in the recycling thereof and provides a solution to environmental land fill, pollution, and waste material management.

20. A container in the shape of a bottle for containing and dispensing a product comprising
a top portion provided with a lip for receiving or dispensing a product from the container wherein the top portion is provided with a lower edge and overhang clip section having a bottom tip, and wherein the container has a vertical centre-line, and
a body portion having a plurality of inwardly facing linear wall configurations, which linearly facing toward the vertical centre-line of the container and wherein the inwardly facing linear wall configurations lie between horizontal inclusion scored corrugations located on the body portion and
a base portion having a body lower edge and wherein the horizontal inclusion scored corrugations and inwardly facing linear wall configurations, located in the body portion, are constructed to allow and enable the container to be in a fully expanded form or to be collapsed to a fully compact form by compressing the container in a top to bottom manner between the lower edge of the top portion and the top edge of the lower base by causing the inwardly facing linear wall configurations to reduce in size vertically and the horizontal inclusion scored corrugations enlarge in size horizontally outwardly and nest vertically, as body portion collapses, and wherein the nested scored corrugations rest on outer edge, of base portion, and outer edge resiliently clips under the bottom tip of and into the overhang clip section to thereby secure the nested scored corrugations to the container top portion and wherein the container is of a circular cross-section shape and wherein the vertical height of the container is substantially greater than its circular cross-sectional dimension and wherein the container and the lip is of a circular cross-sectional shape and wherein the container is further provided with a detachable and removable teat element attachable by a screw or a snap closure element to the container wherein teat element is provided with a teat or nipple feature, a cap and flexible tether connector attaching cap to teat element and wherein the teat or nipple feature allows for drinking by sucking by a container user and wherein
the container is capable of receiving and containing a product in fluid form and wherein the product can be a gas, solid or liquid and wherein the product may consist a liquid unrestricted to water, flavoured drinks, milk, soft drink, sodas, tea, and pharmaceutical products and wherein
the container in a fully expanded form can contain a maximum amount of fluid or liquid and wherein the container may be partially collapsed as the product is dispensed may continue to be used and further collapsed as the product is dispensed and wherein
the container is constructed to be stored in a collapsed fully compact form reducing storage requirements thereof or assists in the recycling thereof and provides a solution to environmental land fill, pollution, and waste material management.
